(19) United States
(12) Patent Application Publication
(10) Pub. No.: US 2025/0368091 A1
(43) Pub. Date: Dec. 4, 2025

(54) METHOD AND SYSTEM FOR CONTROLLING A VEHICLE BASED ON VEHICLE STATE INFORMATION AND PARCEL INFORMATION OF AN ECO-FRIENDLY VEHICLE

(71) Applicants: HYUNDAI MOTOR COMPANY, Seoul (KR); KIA CORPORATION, Seoul (KR)

(72) Inventors: Gyu Ri Lee, Hwaseong-si (KR); Do Hwa Kim, Hwaseong-si (KR); Sung Bae Jeon, Hwaseong-si (KR); Dae Yeong Kim, Hwaseong-si (KR); Tae Hyun Lee, Hwaseong-si (KR); Ji Hoon Kang, Hwaseong-si (KR); Yong Joo Lee, Hwaseong-si (KR)

(73) Assignees: HYUNDAI MOTOR COMPANY, Seoul (KR); KIA CORPORATION, Seoul (KR)

(21) Appl. No.: 18/953,907

(22) Filed: Nov. 20, 2024

(30) Foreign Application Priority Data
Jun. 3, 2024 (KR) 10-2024-0072565

(51) Int. Cl. B60L 58/12; B60L 1/00; B60W 40/13; G06Q 10/0835

(52) U.S. Cl. CPC B60L 58/12; B60L 1/00; B60W 40/13; G06Q 10/08355

(57) ABSTRACT

A method for controlling a vehicle based on vehicle state information and parcel information of an eco-friendly vehicle includes obtaining information about the vehicle or parcels from an external device or at least one sensor. The method further includes determining loading or unloading of the parcels based on the information about the vehicle or the parcels. The method further includes determining a required State Of Charge (SOC) of a battery of the vehicle based on the loading or the unloading of the parcels and the information about the vehicle or the parcels. The method further includes controlling the battery of the vehicle based on the required SOC of the battery of the vehicle or providing a driver with information about the required SOC of the battery of the vehicle.

### CROSS REFERENCE TO RELATED APPLICATION

The present application claims the benefit of and priority to Korean Patent Applications No. 10-2024-0072565, filed Jun. 3, 2024, the entire contents of which are incorporated herein by reference.

### TECHNICAL FIELD

The present disclosure relates to an eco-friendly vehicle and particularly relates to a method and a system for controlling a vehicle based on vehicle state information and parcel information of an eco-friendly vehicle.

### BACKGROUND

It is an international trend to apply eco-friendly factors, such as saving of energy and collecting and recycling of wastes, to management of supply chains including design, manufacture, and delivery of products in the distribution industry. Recently, regulations are being reinforced in relation to the environment and energy in countries around the world. Therefore, enterprises also are recognizing and starting eco-friendly management in terms of sustainable growth. In other words, as environmental factors are integrated to the conventional concept of supply chain management, application of technologies is being changed into a direction including even a forward direction and a backward direction. For example, with the advent of places such as the Zero Emissions Delivery Zone in Santa Monica, the necessity of eco-friendly distribution/home delivery vehicles is increasing.

Meanwhile, as the home delivery service is developed, the current home delivery produces carbon dioxide accompanying combustion of fossil fuel in a large quantity. Particularly, distribution/home delivery vehicles are frequently driven at a low speed or stopped at some places including downtown areas or apartment complexes.

Further, an unmanned delivery robot technology using an autonomous driving technology is being developed in various ways, but the limitation in charging, etc. act as barriers in activation of the technology.

Accordingly, a vehicle control technology specified for a home delivery vehicle mode of eco-friendly vehicles and a technology of efficiently charging an unmanned delivery robot through a home delivery vehicle, etc. are currently required in this field.

The subject matter described in this background section is intended to promote an understanding of the background of the disclosure and thus may include subject matter that is not already known to those of ordinary skill in the art.

### SUMMARY

An objective of the present disclosure is to provide a vehicle control technology specified for a home delivery vehicle mode of eco-friendly vehicles.

Another objective of the present disclosure is to distinguish loading and unloading situations based on variation of an estimated weight, stop information, door opening information, navigation information, etc. of a home delivery vehicle.

Another objective of the present disclosure is to secure a State Of Charge (SOC) of an automotive battery before entering a delivery destination, such as an apartment complex, where there is likely to be significant low-speed driving or stopping during package delivery.

Another objective of the present disclosure is to obtain weight and delivery location information from barcode information on a home delivery box and perform SOC balancing control of a vehicle based on the information.

Another objective of the present disclosure is to provide a technology of charging the battery of an unmanned delivery robot up to an expected State Of Charge (SOC) through a vehicle.

The technical subjects to implement in the present disclosure are not limited to the technical problems described above. Other technical subjects that are not stated herein should be clearly understood by those having ordinary skill in the art from the following descriptions.

In order to achieve the objectives described above, a method of controlling a vehicle according to an embodiment of the present disclosure includes obtaining information about the vehicle or parcels from an external device or at least one sensor. The method also includes determining loading or unloading of the parcels based on the information about the vehicle or the parcels. The method also includes determining a required State of Charge (SOC) of a battery of the vehicle based on the loading or the unloading of the parcels and the information about the vehicle or the parcels. The method also includes controlling charging of the battery of the vehicle based on the required SOC of the battery of the vehicle or providing a driver with information about the required SOC of the battery of the vehicle.

The method of controlling a vehicle may further include determining a required SOC of a delivery robot based on the information about the parcels. The method may further include controlling charging of a battery of the delivery robot based on the required SOC of the delivery robot.

The method of controlling a vehicle may further include determining whether delivery of the parcels has been started. The method may further include, in response that delivery of the parcels has been started, determining the required SOC of the battery of the vehicle.

The method may further include determining whether delivery of the parcels has been started based on the loading or the unloading.

The method of controlling a vehicle may further include determining whether the parcels are being unloaded or are about to be unloaded from the vehicle. The method may further include, in response that the parcels are being unloaded or are about to be unloaded from the vehicle, determining the required SOC of the battery of the vehicle.

The method may further include determining the required SOC of the battery of the vehicle based on entire weight of the vehicle and an estimated travel distance.

The method may further include determining the entire weight of the vehicle by adding up empty carriage weight of the vehicle and weight of the parcels.

The method may further include obtaining the weight of the parcels by scanning a barcode attached on a box of each of the parcels through a camera sensor or a barcode sensor.

The method may further include determining the estimated travel distance of the vehicle based on destination location information of the parcels. The method may further include obtaining the destination location information of each of the parcels by scanning a barcode attached to a box of each of the parcels through a camera sensor or a barcode sensor.

The method may further include classifying parcels into a plurality of groups based on destination location information of the parcels. The method may further include allocating the groups to different delivery robots, respectively. The method may further include determining an optimal route for each of the delivery robots based on destination location information of parcels allocated to each of the delivery robots. The method may further include determining the required SOC of a delivery robot based on the optimal route.

According to another embodiment, a system for controlling a vehicle includes at least one sensor configured to obtain information about the vehicle or parcels. The system further includes a vehicle control unit configured to determine loading or unloading of the parcels based on the information about the vehicle or the parcels. The vehicle control unit is further configured to determine a required State of Charge (SOC) of a battery of the vehicle based on the loading or the unloading of the parcels and the information about the vehicle or the parcels. The vehicle control unit is further configured to control charging of the battery of the vehicle based on the required SOC of the battery of the vehicle or provide a driver with information about the required SOC of the battery of the vehicle.

The vehicle control unit may determine a required SOC of a delivery robot based on the information about the parcels. The vehicle control unit may control charging of a battery of the delivery robot based on the required SOC of the delivery robot.

The vehicle control unit may determine whether delivery of the parcels has been started. In response that delivery of the parcels has been started, the vehicle control unit may determine the required SOC of the battery of the vehicle.

The vehicle control unit may determine whether delivery of the parcels has been started based on the loading or the unloading of the parcels.

The vehicle control unit may determine whether the parcels are being unloaded or are about to be unloaded from the vehicle. The vehicle control unit may determine the required SOC of the battery of the vehicle in response to a determination that the parcels are being unloaded or are about to be unloaded from the vehicle.

The vehicle control unit may determine the required SOC of the battery of the vehicle based on entire weight of the vehicle and an estimated travel distance.

The vehicle control unit may determine the entire weight of the vehicle by adding up empty carriage weight of the vehicle and weight of the parcels.

The vehicle control unit may obtain the weight of the parcels by scanning a barcode attached on a box of each of the parcels through a camera sensor or a barcode sensor.

The vehicle control unit may determine the estimated travel distance of the vehicle based on destination location information of the parcels. The vehicle control unit may obtain the destination location information of each of the parcels by scanning a barcode attached to a box of each of the parcels through a camera sensor or a barcode sensor.

The vehicle control unit may classify the parcels into a plurality of groups based on destination location information of the parcels. The vehicle control unit may allocate the groups to different delivery robots, respectively. The vehicle control unit may determine an optimal route for each of the delivery robots based on destination location information of parcels allocated to each of the delivery robots. The vehicle control unit may determine the required SOC of a delivery robot based on the optimal route.

According to the present disclosure, a vehicle control technology specified for a home delivery vehicle mode of an eco-friendly vehicle is provided.

Further, it may distinguish loading and unloading situations based on variation of estimated weight, stop information, door opening information, navigation information, etc. of a home delivery vehicle.

Further, it may secure an SOC of an automotive battery before the home delivery vehicle enters an expected home delivery destination place in response to a determination that it is expected that there will be many low-speed driving or stopping cases like an apartment complex.

Further, it may obtain weight and delivery location information from barcode information on a home delivery box and perform Soc balancing control of a vehicle based on the information.

Further, a technology of charging the battery of an unmanned delivery robot up to an expected State of Charge (SOC) through a vehicle is provided.

### BRIEF DESCRIPTION OF THE DRAWINGS

The above and other objectives, features, and other advantages of the present disclosure should be more clearly understood from the following detailed description when taken in conjunction with the accompanying drawings, in which:

FIG. 1 is a flowchart illustrating the concept of a method and system for controlling a vehicle based vehicle state information and parcel information of an eco-friendly vehicle according to an embodiment of the present disclosure;

FIG. 2 is a block diagram showing the structure of a system for controlling a vehicle according to an embodiment of the present disclosure; and

FIG. 3 is a flowchart showing a method of controlling a vehicle according to an embodiment of the present disclosure.

### DETAILED DESCRIPTION

Hereafter, embodiments of the present disclosure are described in detail with reference to the accompanying drawings and the same or similar components are given the same reference numerals regardless of the numbers of figures and are not repeatedly described. Terms “module” and “unit” that are used for components in the present disclosure are used only for the convenience of description without having different meanings or functions. In the following description, if it is decided that the detailed description of known technologies related to the present disclosure makes the subject matter of the embodiments described herein unclear, the detailed description is omitted. Further, the accompanying drawings are provided only for easy understanding of embodiments disclosed in the present disclosure. The technical spirit disclosed in the present disclosure is not limited by the accompanying drawings. All changes, equivalents, and replacements should be understood as being included in the spirit and scope of the present disclosure.

Terms including ordinal numbers such as “first” and “second” may be used to describe various components. However, the components should not be construed as being limited to the terms. The terms are used only to distinguish one component from another component.

It should be understood that when one element is referred to as being “connected to” or “coupled to” another element, it may be connected directly to or coupled directly to another element or be connected to or coupled to another element with the other element therebetween. On the other hand, it should be understood that when one element is referred to as being “connected directly to” or “coupled directly to” another element, it may be connected to or coupled to another element without the other element therebetween.

Singular forms are intended to include plural forms unless the context clearly indicates otherwise.

It should be further understood that the terms “comprise” or “have” used in the present disclosure specify the presence of stated features, steps, operations, components, parts, or a combination thereof. However, the terms do not preclude the presence or addition of one or more other features, numerals, steps, operations, components, parts, or a combination thereof. When a controller, module, component, device, element, or the like of the present disclosure is described as having a purpose or performing an operation, function, or the like, the controller, module, component, device, element, or the like should be considered herein as being “configured to” meet that purpose or to perform that operation or function. Each controller, module, component, device, element, and the like may separately embody or be included with a processor and a memory, such as a non-transitory computer readable media, as part of the apparatus.

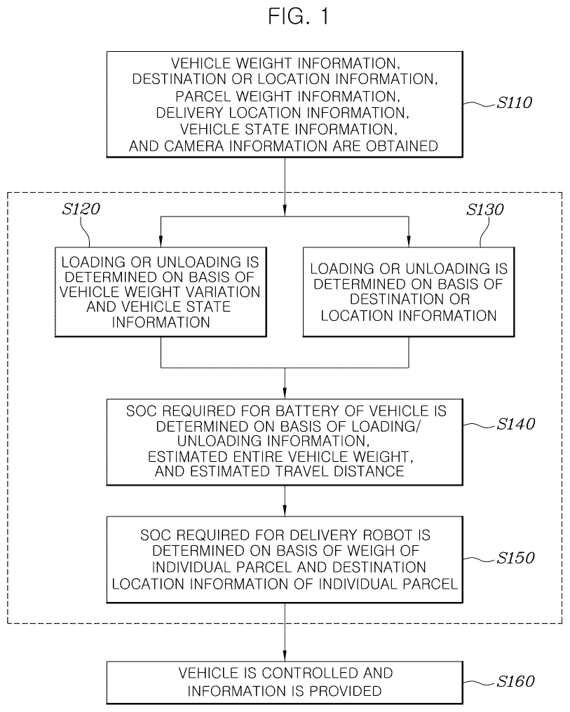

FIG. 1 is a flowchart illustrating the concept of a method and system for controlling a vehicle based vehicle state information and parcel information of an eco-friendly vehicle according to an embodiment of the present disclosure.

Referring to FIG. 1, a system for controlling a vehicle obtains empty carriage weight information of the vehicle, destination or location information, parcel weight information, delivery location information, vehicle state information, and camera sensor information through a plurality of sensors, a navigation system, a communication module, etc. (S110).

In this case, the empty carriage weight information of the vehicle can be obtained by a weight sensor or can be received by an external device or user's input.

In this case, the parcel weight information and delivery location information can be obtained by scanning a barcode attached to the box of each parcel through a camera sensor or a barcode sensor.

In this case, the destination or location information of a vehicle can be obtained from a navigation system or a Global Positioning System (GPS) of the vehicle.

In this case, the vehicle state information may include stop information or door opening/closing information of the vehicle obtained by a speed sensor or a door sensor.

Further, the system for controlling a vehicle determines loading or unloading of a parcel based on vehicle weight variation and vehicle state information (S120).

In this case, the vehicle weight variation may be determined based on barcode information of a parcel.

For example, when a barcode attached to a parcel can be recognized, loading can be determined when the barcode attached to the parcel is recognized first time, and unloading of the parcel can be determined when the barcode is recognized second time.

In this case, when the entire weight of a vehicle is higher than before, it is possible to determine that a parcel has been loaded.

In this case, when the entire weight of a vehicle is lower than before, it is possible to determine that parcels are being unloaded.

In this case, when a slope is converted into a flat ground and acceleration is high at the same torque before the vehicle is stopped, it means that the entire weight of the vehicle decreased, so unloading of parcels can be determined. When acceleration is low, it means that the entire weight of the vehicle increased, so loading can be determined.

In this case, when the number of times of stopping the vehicle is a preset number of times or more, it is possible to determine that parcels are being unloaded.

In this case, when a door of the vehicle is opened and closed a preset number of times or more within a predetermined time, it is possible to determine that parcels are being unloaded.

Further, the system for controlling a vehicle determines loading or unloading of parcels based on destination or location information of the vehicle (S130).

In this case, when the current location of a vehicle is going out of a distribution center, it is possible to determine that loading of parcels has been finished.

In this case, when the current location of the vehicle approaches within a threshold distance from the destination set in the vehicle, it is possible to determine that parcels are being unloaded or are about to be unloaded.

Further, the system for controlling a vehicle determines a State Of Charge (SOC) required for the battery of a vehicle based on loading/unloading information, entire vehicle weight, and an estimated travel distance (S140).

In this case, the system for controlling a vehicle can determine a required SOC of the battery of the vehicle based on the entire weight of the vehicle and the estimated travel distance when determining that the vehicle is about to be unloaded after loading is finished.

In this case, the estimated travel distance may be determined based on the delivery location information of parcels.

Further, the system for controlling a vehicle determines a required SOC of a delivery robot based on the weight of parcels and the delivery location information of parcels (S150).

Meanwhile, a delivery robot stated in the present disclosure may be a robot that can be mounted on a vehicle with parcels and can deliver parcels to final destinations through autonomous driving after the vehicle is parked or stopped adjacent to delivery destinations.

Further, the delivery robot may be loaded in a chargeable state on a vehicle so that it can be charged into a required SOC while the vehicle is moving.

In this case, the distance from the stop position of the home delivery vehicle to a final delivery destination can be considered for the required SOC of the delivery robot.

In this case, parcels can be classified into a plurality of groups based on the deliver location information, and the groups can be allocated to different delivery robots, respectively.

In this case, the system for controlling a vehicle can determine an optimal route for each delivery robot based on the parcel allocated to each delivery robot and can determine a required SOC based on the route.

Further, the system for controlling a vehicle controls the vehicle or provides information to the driver based on the Soc required for the battery of the vehicle or the SOC required for a delivery robot determined in step S140 or step S150 (S160).

In this case, the system for controlling a vehicle can instruct the driver to drive the vehicle to a close charging station or to move the vehicle based on the SOC of the battery of the vehicle determined in step S140.

In this case, the system for controlling a vehicle can control the vehicle to charge the battery of the vehicle up to a required SOC from the current remaining SOC.

In this case, the system for controlling a vehicle can control the vehicle to charge a delivery robot up to a required SOC from the remaining SOC using a Vehicle to Load (V2L) function.

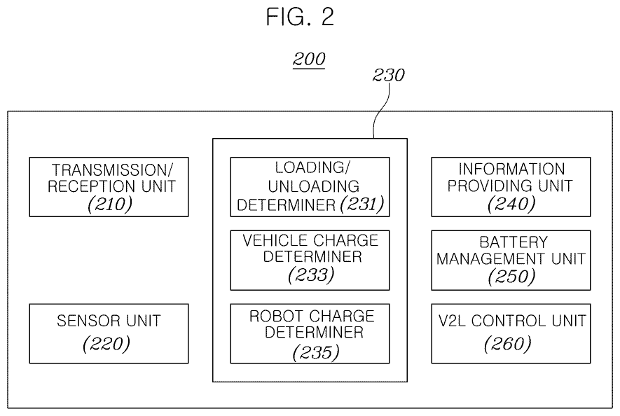

FIG. 2 is a block diagram showing the structure of a system for controlling a vehicle according to an embodiment of the present disclosure.

Meanwhile, although a driving source for a vehicle is not shown in detail in FIG. 1, the vehicle may be an Electric Vehicle (EV) including an electric motor as a driving source so that it can be driven in an EV mode at least adjacent to destinations. The vehicle may be an Hybrid Electric Vehicle (HEV) equipped with an engine too so that it can be driven without consumption of a battery and can be charged in order to manage the SOC during driving.

Referring to FIG. 2, a system 200 for controlling a vehicle according to this embodiment includes a transmission/reception unit 210, a sensor unit 220, a vehicle control unit 230, an information providing unit 240, a battery management unit 250, and a V2L control unit 260.

The transmission/reception unit 210 receives destination information of the vehicle from an external server or an external device.

The transmission/reception unit 210 may include a communication module for communicating with an external server or an external device.

In this case, the external device, for example, may be a navigation system installed in the vehicle.

The sensor 220 obtains at least one piece of sensing information for controlling the vehicle from at least one sensor.

Though not shown in the figure, the sensor unit 220 may include at least one or more of a GPS sensor, a weight sensor, a camera sensor, a barcode sensor, or a combination thereof.

The vehicle control unit 230 determines loading or unloading based on the pieces of information obtained by the transmission/reception unit 210 or the sensor unit 220 or determines an SOC for the battery of the vehicle or an SOC for a delivery robot.

The vehicle control unit 230 includes a loading/unloading determiner 231, a vehicle charge determiner 233, and a robot charge determiner 235.

The loading/unloading determiner 231 determines loading or unloading based on the pieces of information obtained by the transmission/reception unit 210 or the sensor unit 220.

In this case, the loading/unloading determiner 231 can determine loading or unloading of a parcel based on vehicle weight variation and vehicle state information.

In this case, the vehicle weight variation may be determined based on barcode information of a parcel.

For example, when a barcode attached to a parcel can be recognized, loading can be determined when the barcode attached to the parcel is recognized first time, and unloading of the parcel can be determined when the barcode is recognized second time.

In this case, when the entire weight of the vehicle is higher than before, it is possible to determine that a parcel has been loaded.

In this case, when the entire weight of the vehicle is lower than before, it is possible to determine that a parcel has been unloaded.

In this case, when a slope is converted into a flat ground and acceleration is high at the same torque before the vehicle is stopped, it means that the entire weight of the vehicle decreased, so unloading of parcels can be determined. When acceleration is low, it means that the entire weight of the vehicle increased, so loading can be determined.

In this case, when the number of times of stopping the vehicle is a preset number of times or more, it is possible to determine that parcels are being unloaded.

In this case, when a door of a vehicle is opened and closed a preset number of times or more within a predetermined time, it is possible to determine that parcels are being unloaded.

Further, the loading/unloading determiner 231 can determine loading or unloading of parcels based on destination or location information of the vehicle.

In this case, when the current location of a vehicle is going out of a distribution center, it is possible to determine that unloading of parcels has been finished.

In this case, when the current location of the vehicle approaches within a threshold distance from the destination set in the vehicle, it is possible to determine that parcels are being unloaded or are expected to be unloaded.

The vehicle charge determiner 233 determines an SOC required for the battery of the vehicle based on loading/unloading information, an entire vehicle weight, and an estimate travel distance. The vehicle charge determiner 233 determines whether the battery of the vehicle needs to be additionally charged and the capacity of the battery required in additional charging.

In this case, the vehicle charge determiner 233 can determine a required SOC of the battery of the vehicle based on the entire weight of the vehicle and the estimated travel distance when determining that the vehicle is about to be unloaded after loading is finished.

In this case, the entire weight of the vehicle can be calculated by adding up the empty carriage weight of the vehicle and the weight of parcels.

In this case, the estimated travel distance may be determined based on the delivery location information of parcels.

The robot charge determiner 235 determines an SOC required for a delivery robot based on the weight of parcels and the delivery location information of the parcels. The robot charge determiner 235 determines whether the battery of the robot needs to be additionally charged and the capacity of the battery required in additional charging.

In this case, the distance from the stop position of the home delivery vehicle to a final delivery destination can be considered for the required SOC of the delivery robot.

In this case, parcels can be classified into a plurality of groups based on the deliver location information, and the parcels of the groups can be allocated to one or more corresponding delivery robots, respectively.

In this case, the robot charge determiner 235 can determine an optimal route for each delivery robot based on the parcel allocated to each delivery robot. The robot charge determiner 235 can determine a required SOC based on the route.

The information providing unit 240 provides the driver with information about the required SOC for the battery of the vehicle, whether the battery of the vehicle needs to be additionally charged, or the capacity of the battery required in additional charging that has been determined by the vehicle charge determiner 233.

In this case, the information providing unit 24 may include a display screen or a speaker in the vehicle. The information providing unit 24 can provide the driver with information about the required SOC for the battery of the vehicle, whether the battery of the vehicle needs to be additionally charged, or the capacity of the battery required in additional charging through the display screen or a voice from the speaker.

The battery management unit 250 controls changing of the battery of the vehicle based on the required SOC for the battery of the vehicle, whether the battery of the vehicle needs to be additionally charged, or the capacity of the battery required in additional charging that has been determined by the vehicle charge determiner 233.

The V2L control unit 260 controls charging of a delivery robot based on the Soc required for the delivery robot, whether the battery of the robot needs to be additionally charged, or the capacity of the battery required in additional charging that has been determined by the robot charge determiner 235.

In this case, the distance from the stop position of the home delivery vehicle to a final delivery destination can be considered for the required SOC of the delivery robot.

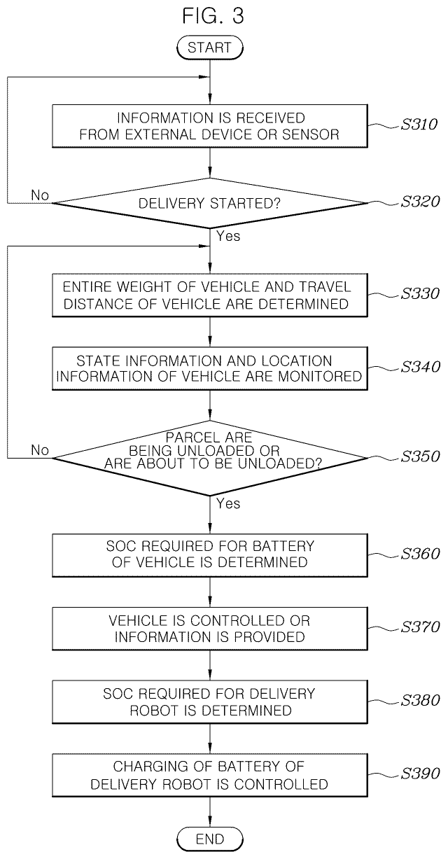

FIG. 3 is a flowchart showing a method of controlling a vehicle according to an embodiment of the present disclosure.

The method of controlling a vehicle according to this embodiment can be performed by the vehicle control unit 230 shown in FIG. 2.

Referring to FIG. 3, the vehicle control unit 230 obtains information about the vehicle or a parcel from an external device or at least one or more sensor (S310).

In this case, the information about the vehicle or a parcel may include one or more of empty carriage weight information of the vehicle, destination or current location information of the vehicle, parcel weight information, destination location information, vehicle state information, camera sensor information, or a combination thereof.

In this case, the empty carriage weight information can be obtained by a weight sensor or can be received by an external device or user's input.

In this case, the delivery location information can be obtained by scanning a barcode attached to the box of each parcel through a camera sensor or a barcode sensor.

In this case, the destination or current location information of the vehicle can be obtained from a navigation system or GPS of the vehicle.

In this case, the vehicle state information may include stop information or door opening/closing information of the vehicle obtained by a speed sensor or a door sensor.

In this case, the empty carriage weight information of the vehicle can be obtained by a weight sensor or can be received by an external device or user's input.

In this case, the delivery location information can be obtained by scanning a barcode attached to the box of each parcel through a camera sensor or a barcode sensor.

In this case, the destination or location information of a vehicle can be obtained from a navigation system or a Global Positioning System (GPS) of the vehicle.

In this case, the vehicle state information may include stop information or door opening/closing information of the vehicle obtained by a speed sensor or a door sensor.

Further, the vehicle control unit 230 determines whether delivery of parcels has been started (S320).

In this case, whether delivery of parcels has been started can be determined based on loading or unloading of the vehicle (S320).

In this case, loading or unloading of a parcel can be determined based on at least one or more pieces of information received in step S310.

In this case, loading or unloading of a parcel can be determined based on vehicle weight variation and vehicle state information.

In this case, the vehicle weight variation may be determined based on barcode information of a parcel.

For example, when a barcode attached to a parcel can be recognized, loading can be determined when the barcode attached to the parcel is recognized first time. Unloading of the parcel can be determined when the barcode is recognized second time.

In this case, when the entire weight of the vehicle is higher than before, it is possible to determine that a parcel has been loaded.

In this case, when the entire weight of the vehicle is lower than before, it is possible to determine that a parcel has been unloaded.

In this case, when a slope is converted into a flat ground and acceleration is high at the same torque before the vehicle is stopped, it means that the entire weight of the vehicle decreased, so unloading of parcels can be determined. When acceleration is low, it means that the entire weight of the vehicle increased, so loading can be determined.

In this case, when it is determined that loading of parcels has been finished, it is possible to determine that delivery has been started.

In this case, when the entire weight of the vehicle is higher than before, it is possible to determine that a parcel has been loaded.

Further, loading or unloading of parcels can be determined based on destination or location information of the vehicle.

In this case, when the current location of a vehicle is going out of a distribution center, it is possible to determine that loading of parcels has been finished.

Further, when it is determined that delivery of parcels has been started (Yes in S320), the vehicle control unit 230 determines the entire weight of the vehicle and the travel distance of the vehicle (S330).

In this case, the entire weight of the vehicle can be calculated by adding up the empty carriage weight of the vehicle and the weight of parcels.

In this case, the empty carriage weight of the vehicle can be obtained by a weight sensor or can be received by an external device or user's input.

In this case, the weight of a parcel can be obtained by scanning a barcode attached to the box of each parcel through a camera sensor or a barcode sensor.

In this case, the travel distance of the vehicle can be determined by obtaining destination location information by scanning barcodes attached on the box of each parcel through a camera sensor or a barcode sensor and by determining an optimal route of the vehicle based on the destination location information.

Further, the vehicle control unit 230 monitors state information and location information of the vehicle (S340). The vehicle control unit 230 determines whether parcels are being unloaded or are about to be unloaded from the vehicle (S350). The vehicle control unit 230 determines a required SOC of the battery of the vehicle (S360) when parcels are being unloaded or are about to be unloaded from the vehicle (Yes in S350).

In this case, when the entire weight of a vehicle is lower than before, it is possible to determine that parcels are being unloaded.

In this case, when the number of times of stopping the vehicle is a preset number of times or more, it is possible to determine that parcels are being unloaded.

In this case, when a door of the vehicle is opened and closed a preset number of times or more within a predetermined time, it is possible to determine that parcels are being unloaded.

In this case, when the current location of the vehicle approaches within a threshold distance from the destination set in the vehicle, it is possible to determine that parcels are being unloaded or are expected to be unloaded.

In this case, the vehicle control unit 230 can determine a required SOC of the battery of the vehicle based on the entire weight of the vehicle and the estimated travel distance.

In this case, the estimated travel distance may be determined based on the delivery location information of each parcel.

Further, the vehicle control unit 230 controls the vehicle or provides information to the driver based on the required SOC of the battery of the vehicle determined in step S360 (S370).

For example, when the vehicle is a Hybrid Electric Vehicle (HEV), the vehicle control unit 230 controls charging of the battery of the vehicle by operating the engine of the vehicle.

Meanwhile, when the vehicle is an Electric Vehicle (EV), the vehicle control unit 230 can move the vehicle to a charging station for electric vehicles.

Further, the vehicle control unit 230 determines a required SOC of a delivery robot based on the weight of parcels and destination location information of the parcels (S380). The vehicle control unit 230 controls charging of the battery of the delivery robot based on the required SOC (S390).

In this case, controlling of the battery of the delivery robot can be performed by controlling the V2L control unit 260.

In this case, the distance from the stop position of the home delivery vehicle to a final delivery destination can be considered for the required SOC of the delivery robot.

According to the embodiments of the present disclosure described above, a vehicle control technology specified for a home delivery vehicle mode of an eco-friendly vehicle is provided.

Further, it is possible to distinguish loading and unloading situations based on variation of estimated weight, stop information, door opening information, navigation information, etc. of a home delivery vehicle.

Further, it is possible to secure an SOC of an automotive battery before the home deliver vehicle enters an expected home delivery destination place when it is expected that there will be many low-speed driving or stopping cases like an apartment complex.

Further, it is possible to obtain weight and delivery location information from barcode information on a home delivery box and perform Soc balancing control of a vehicle based on the information.

Further, a technology of charging the battery of an unmanned delivery robot up to an expected State Of Charge (SOC) through a vehicle is provided.

The present disclosure can be achieved as computer-readable codes on a program-recoded medium. A computer-readable medium includes all kinds of recording devices that keep data that can be read by a computer system. For example, the computer-readable medium may be an HDD (Hard Disk Drive), an SSD (Solid State Disk), an SDD (Silicon Disk Drive), a ROM, a RAM, a CD-ROM, a magnetic tape, a floppy disk, and an optical data storage. Accordingly, the detailed description should not be construed as being limited in all respects and should be construed as an example. The scope of the present disclosure should be determined by reasonable analysis of the claims and all changes within an equivalent range of the present disclosure are included in the scope of the present disclosure.

What is claimed is:

1. A method of controlling a vehicle, the method comprising:
obtaining information about the vehicle or parcels from an external device or at least one sensor;
determining loading or unloading of the parcels based on the information about the vehicle or the parcels;
determining a required State Of Charge (SOC) of a battery of the vehicle based on the loading or the unloading of the parcels and the information about the vehicle or the parcels; and
controlling the battery of the vehicle based on the required SOC of the battery of the vehicle or providing a driver with information about the required SOC of the battery of the vehicle.

2. The method of claim 1, further comprising:
determining a required SOC of a delivery robot based on the information about the parcels; and
controlling charging of a battery of the delivery robot based on the required SOC of the delivery robot.

3. The method of claim 1, further comprising:
determining whether delivery of the parcels has been started; and
in response to a determination that delivery of the parcels has been started, determining the required SOC of the battery of the vehicle.

4. The method of claim 3, further comprising determining whether delivery of the parcels has been started based on the loading or the unloading of the parcels.

5. The method of claim 3, further comprising:
determining whether the parcels are being unloaded or are about to be unloaded from the vehicle; and
in response to a determination that the parcels are being unloaded or are about to be unloaded from the vehicle, determining the required SOC of the battery of the vehicle.

6. The method of claim 1, further comprising determining the required SOC of the battery of the vehicle based on entire weight of the vehicle and an estimated travel distance.

7. The method of claim 6, further comprising determining the entire weight of the vehicle by adding up empty carriage weight of the vehicle and weight of the parcels.

8. The method of claim 7, further comprising obtaining the weight of the parcels by scanning a barcode attached on a box of each of the parcels through a camera sensor or a barcode sensor.

9. The method of claim 6, further comprising:
determining the estimated travel distance of the vehicle based on destination location information of the parcels; and
obtaining the destination location information of each of the parcels by scanning a barcode attached to a box of each of the parcels through a camera sensor or a barcode sensor.

10. The method of claim 2, further comprising:
classifying the parcels into a plurality of groups based on destination location information of the parcels;
allocating the groups to different delivery robots, respectively;
determining an optimal route for each of the delivery robots based on destination location information of parcels allocated to each of the delivery robots; and
determining the required SOC of a delivery robot based on the optimal route.

11. A system for controlling a vehicle, the system comprising:
at least one sensor configured to obtain information about the vehicle or parcels; and
a vehicle control unit configured to:
determine loading or unloading of the parcels based on the information about the vehicle or the parcels;
determine a required State Of Charge (SOC) of a battery of the vehicle based on the loading or the unloading of the parcels and the information about the vehicle or the parcels; and
control the battery of the vehicle based on the required SOC of the battery of the vehicle or provide a driver with information about the required SOC of the battery of the vehicle.

12. The system of claim 11, wherein the vehicle control unit is further configured to:
determine a required SOC of a delivery robot based on the information about the parcels; and
control charging of a battery of the delivery robot based on the required SOC of the delivery robot.

13. The system of claim 11, wherein the vehicle control unit is further configured to:
determine whether delivery of the parcels has been started, and
determine the required SOC of the battery of the vehicle in response to a determination that delivery of the parcels has been started.

14. The system of claim 13, wherein the vehicle control unit is further configured to determine whether delivery of the parcels has been started based on the loading or the unloading of the parcels.

15. The system of claim 13, wherein the vehicle control unit is further configured to:
determine whether the parcels are being unloaded or are about to be unloaded from the vehicle; and
determine the required SOC of the battery of the vehicle in response to a determination that the parcels are being unloaded or are about to be unloaded from the vehicle.

16. The system of claim 11, the vehicle control unit is further configured to determine the required SOC of the battery of the vehicle based on entire weight of the vehicle and an estimated travel distance.

17. The system of claim 16, wherein the vehicle control unit is further configured to determine the entire weight of the vehicle by adding up empty carriage weight of the vehicle and weight of the parcels.

18. The system of claim 17, wherein the vehicle control unit is further configured to obtain the weight of the parcels by scanning a barcode attached on a box of each of the parcels through a camera sensor or a barcode sensor.

19. The system of claim 16, wherein the vehicle control unit is further configured to:
determine the estimated travel distance of the vehicle based on destination location information of the parcels; and
obtain the destination location information of each of the parcels by scanning a barcode attached to a box of each of the parcels through a camera sensor or a barcode sensor.

20. The system of claim 12, wherein the vehicle control unit is further configured to:
classify the parcels into a plurality of groups based on destination location information of the parcels;
allocating the groups to different delivery robots, respectively;
determining an optimal route for each of the delivery robots based on destination location information of parcels allocated to each of the delivery robots; and
determining the required SOC of a delivery robot based on the optimal route.
